(19) United States
(12) Patent Application Publication
(10) Pub. No.: US 2021/0374774 A1
(43) Pub. Date: Dec. 2, 2021

(54) SYSTEMS AND METHODS FOR PROVIDING VENDOR RECOMMENDATIONS

(71) Applicant: CAPITAL ONE SERVICES, LLC, McLean, VA (US)

(72) Inventors: Elizabeth Furlan, Plano, TX (US); Chih-Hsiang Chow, Plano, TX (US); Steven Dang, Plano, TX (US)

(73) Assignee: CAPITAL ONE SERVICES, LLC, McLean, VA (US)

(21) Appl. No.: 16/890,371

(22) Filed: Jun. 2, 2020

(51) Int. Cl. G06Q 30/02

(52) U.S. Cl. CPC G06Q 30/0202; G06N 20/00; G06Q 30/0282

(57) ABSTRACT

A method includes determining a vendor interaction preference profile of a customer, which may include: receiving one or more vendor reviews authored by the customer; performing a content analysis process on the reviews to associate at least one review with at least one quality in a predetermined set of qualities; and performing a sentiment analysis process on the at least one associated review to determine a respective customer preference index value for each quality in the predetermined set of qualities. Additionally, the method may include comparing the vendor interaction preference profile of the customer with an interaction profile of a vendor that may include a respective interaction index value for each quality in the predetermined set of qualities. A predicted interaction metric of the vendor with the customer may be determined based on the comparing, and may be caused to be displayed on a customer device associated with the customer.

### TECHNICAL FIELD

Various embodiments of the present disclosure relate generally to using a machine learning model to recommend vendors to customers, and more particularly, to methods and systems for ingesting social business-review data to understand customer preferences and vendor characteristics when making vendor recommendations.

### BACKGROUND

For a negotiated transaction, such as buying a vehicle, boat, or home, the interaction between customer and vendor can have a large impact on whether the transaction is successful. Thus, the success of a transaction may depend on whether the customer selects a vendor with characteristics that align with the customer's preferences. However, customers and vendors generally have little insight into whether the customer's preferences and the vendor's characteristics align prior to the transaction itself.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure methods, systems, and non-transitory computer-readable media are disclosed for (i) determining the alignment between a customer's preferences and a vendor's characteristics for an interaction pursuant to a negotiated transaction, and (ii) recommending a vendor to the customer based on the determination. Each of the examples disclosed herein may include one or more of the features described in connection with any of the other disclosed examples.

In one example, a computer-implemented method may include determining a vendor interaction preference profile of a customer. Determining the vendor interaction preference profile of a customer may include receiving first data including one or more vendor reviews authored by the customer; performing first content analysis process on the one or more vendor reviews to associate at least one of the one or more vendor reviews with at least one quality in a predetermined set of qualities; and performing a first sentiment analysis process on the at least one vendor review associated with the at least one quality to determine a respective customer preference index value for each quality in the predetermined set of qualities. Additionally, the method may include comparing the vendor interaction preference profile of the customer with an interaction profile of a vendor. The interaction profile of the vendor may include a respective interaction index value for each quality in the predetermined set of qualities. Based on the comparing of the vendor interaction preference profile of the customer with the interaction profile of the vendor, a predicted interaction metric of the vendor with the customer may be determined. The predicted interaction metric may be caused to be displayed on a customer device associated with the customer.

In another example, a computer-implemented method may include determining an interaction profile of one or more vendors. Determining the interaction profile of the one or more vendors may include: generating vendor profile data that includes a respective one or more user reviews authored by one or more users for each vendor of the one or more vendors; for each vendor of the one or more vendors, a first content analysis process may be performed on the respective one or more user reviews to associate at least one of the one or more user reviews with at least one quality in a predetermined set of qualities; and for each vendor of the one or more vendors, a first sentiment analysis process may be performed on the at least one user review associated with at least one quality to determine a respective interaction index value for each quality in the predetermined set of qualities. The method may further include, in response to receiving a request from a customer device associated with a customer, determining an interaction preference profile of the customer. Determining an interaction preference profile of the customer may include generating customer profile data that includes one or more vendor reviews authored by the customer; performing a second content analysis process on the one or more vendor reviews to associate at least one of the one or more vendor reviews with at least one quality in the predetermined set of qualities; and performing a second sentiment analysis process on the at least one vendor review associated with at least one quality to determine a respective customer preference index value for each quality in the predetermined set of qualities. The method may further include comparing the preference profile of the customer with the interaction profiles of at least a portion of the one or more vendors and, based on the comparing the preference profile of the customer with the interaction profiles of the at least the portion of the one or more vendors, determining a respective predicted interaction metric of each of the at least the portion of the one or more vendors with the customer. Further, the method may include causing the respective predicted interaction metric of each of the at least the portion of the one or more vendors to be displayed on the customer device.

In a further example, a system may include a memory storing instructions, and at least one processor executing the instructions to perform a process. The process may include determining an interaction profile of one or more vendors. Determining an interaction profile of one or more vendors may include generating vendor profile data that includes a respective one or more user reviews authored by one or more users for each vendor of the one or more vendors; for each vendor of the one or more vendors, performing a first content analysis process on the respective one or more reviews to associate at least one of the one or more user reviews with at least one quality in a predetermined set of qualities; and for each vendor of the one or more vendors, performing a first sentiment analysis process on the at least one user review associated with at least one quality to determine a respective interaction index value for each quality in the predetermined set of qualities. The process may further include, in response to receiving a request from a customer device associated with a customer, determining an interaction preference profile of the customer. Determining an interaction preference profile of the customer may include generating customer profile data that includes one or more vendor reviews authored by the customer; performing a second content analysis process on the one or more vendor reviews to associate at least one of the one or more vendor reviews with at least one quality in the predetermined set of qualities; performing a second sentiment analysis process on the at least one vendor review associated with at least one quality to determine a respective customer preference index value for each quality in the predetermined set of qualities. Additionally, the method may include comparing the preference profile of the customer with the interaction profiles of at least a portion of the one or more vendors; based on the comparing of the preference profile of the customer with the interaction profiles of the at least the portion of the one or more vendors, determining a respective predicted interaction metric of each of the at least the portion of the one or more vendors with the customer; and causing the respective predicted interaction metrics to be displayed on the customer device.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary client-server environment that may be utilized according to aspects of the present disclosure.

FIG. 2 depicts an exemplary process for using a machine learning model to determine alignment between customer preferences and vendor characteristics for an interaction pursuant to a negotiated transaction.

FIG. 3 depicts an exemplary process for using the machine learning model to determine an interaction profile of one or more vendors.

FIG. 4 depicts an exemplary process for using the machine learning model to generate vendor profile data.

FIG. 5 depicts an exemplary process for using the machine learning model to determine an interaction profile of one or more vendors.

FIG. 6 depicts an exemplary process for using the machine learning model to generate customer profile data.

FIG. 7 depicts an example of a computing device, according to aspects of the present disclosure.

### DETAILED DESCRIPTION OF EMBODIMENTS

The terminology used in this disclosure is to be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “computer system” generally encompasses any device or combination of devices, each device having at least one processor that executes instructions from a memory medium. Additionally, a computer system may be included as a part of another computer system.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially,” “approximately,” “about,” and “generally,” are used to indicate a possible variation of ±10% of a stated or understood value.

As used herein, the term “dealer” may indicate, and may be used interchangeably with, a seller of items or services, a vendor of items or services, etc. The term “client” may indicate, and may be used interchangeably with, a customer, buyer, person attempting to obtain a lease, ownership, ownership share, etc., of an item and/or service.

In general, the present disclosure provides methods and systems for using a machine learning model to ingest social business-review data, identify customer preferences and vendor characteristics, and recommend vendors to customers by leveraging the identified customer preferences and vendor characteristics. As will be discussed below in more detail, in methods and systems according to the present disclosure, existing techniques may be improved.

Generally, conventional vendor recommendation systems operate based on criteria for a transaction submitted by a customer. For example, when searching for a vehicle dealership in order to purchase a new vehicle, a customer may submit a request that specifies a particular make and model of a desired vehicle, a price point, a dealer location, or another criterion for the transaction, whereby the conventional recommendation system provides a list of vendors based on the transaction criteria.

While vendor results based on the submitted criteria can identify vendors with which a transaction is possible, whether the transaction is ultimately successful can depend greatly on the interaction between the customer and the vendor through the course of the transaction. Thus, the success of the transaction may depend, at least in part, upon whether the vendor recommended by the recommendation system and selected by the customer has characteristics that align with the customer's preferences. Because conventional recommendation systems do not have insight into this alignment, the characteristics of the vendor recommended by the system and selected by the customer may not be aligned with the preferences of the customer, which can result in a negative customer experience and/or failure of the transaction.

In an example, a particular customer prefers a minimal amount of haggling in a negotiation, and a particular vendor, while satisfying all of the criteria for the customer's transaction, is characterized as an excessive haggler. Even though the transaction is possible, the transaction may nevertheless result in a negative customer experience and/or fail because of the misalignment between the customer's preferences and the vendor's characteristics.

Moreover, customers and vendors may be unaware of or unable to articulate their preferences and characteristics, respectively. Accordingly, a need exists to determine customer preferences and vendor characteristics, and to leverage these determinations to recommend vendors with characteristics that align with customer preferences.

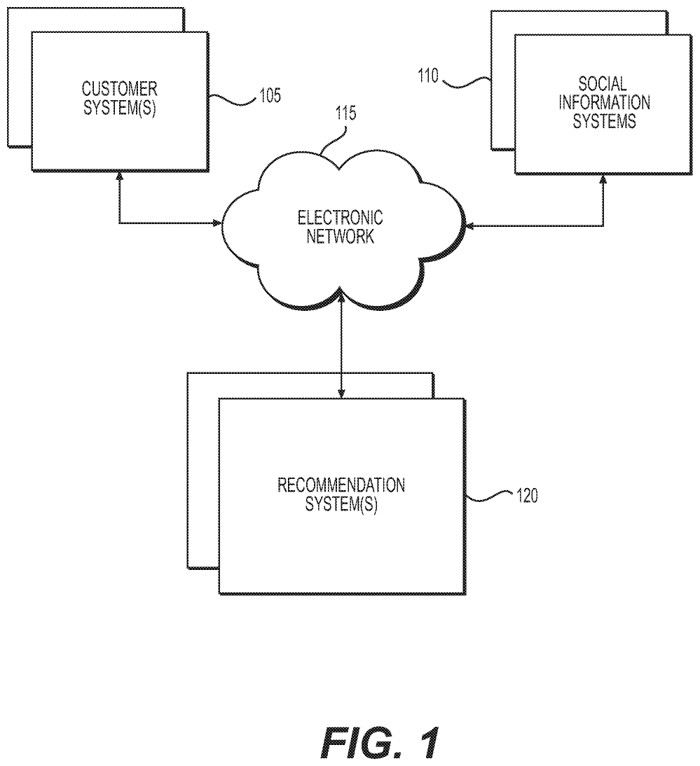

FIG. 1 depicts an exemplary client-server environment that may be utilized with techniques presented herein. One or more customer system(s) 105, and/or one or more social information system(s) 110 may communicate across an electronic network 115. The systems of FIG. 1 may communicate in any arrangement.

The customer system 105 may be associated with a customer, e.g., a customer seeking to find a vendor with which to complete a transaction (e.g., a negotiated transaction). The social information system 110 may be a system that receives, aggregates, solicits, publishes, and/or provides social information submitted by various users. Social information can include, for example, comments and reviews associated with vendors. In some embodiments, the environment includes at least one social information system 110 that is not uniquely associated with a vendor, e.g., a review website that aggregates reviews and comments about various vendors. In some embodiments, the environment includes at least one social information system 110 that is associated with a particular vendor, e.g., a website for a particular vendor that includes user comments associated with the particular vendor. In some embodiments, the environment includes at least one social information system 110 that is not uniquely associated with comments or reviews pertaining to vendors, e.g., a social media website that includes various user information and comments that may or may not relate to a vendor.

As will be discussed herein, one or more recommendation system(s) 120 may communicate with the customer system 105 and/or social information system 110 in executing a machine learning model to determine customer preferences and vendor characteristics, and to recommend vendors to customers based on the determined preferences and characteristics. As used herein, a “machine learning model” may include data (e.g., historical customer or vendor data) or instruction(s) for generating, retrieving, and/or analyzing such data.

In various embodiments, the electronic network 115 may be a wide area network (“WAN”), a local area network (“LAN”), personal area network (“PAN”), or the like. In some embodiments, electronic network 115 includes the Internet, and information and data provided between various systems occurs online. “Online” may mean connecting to or accessing source data or information from a location remote from other devices or networks coupled to the internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”).

While FIG. 1 depicts the various systems as physically separate and communicating across the electronic network 115, in various embodiments features of certain systems, such as the recommendation system 120, may be incorporated partially or completely into any of the other systems of FIG. 1. For example, a portion of the machine learning model may be incorporated into social information system 110 and/or the client system 105. Some or all of the functionality of the recommendation system 120 may be incorporated into customer system 105. For example, some or all of the functionality of the recommendation system 120 may be incorporated into an internet browser extension or website page usable by a customer, such as via customer system 105 or via a social information system 110 or other system accessible by the customer.

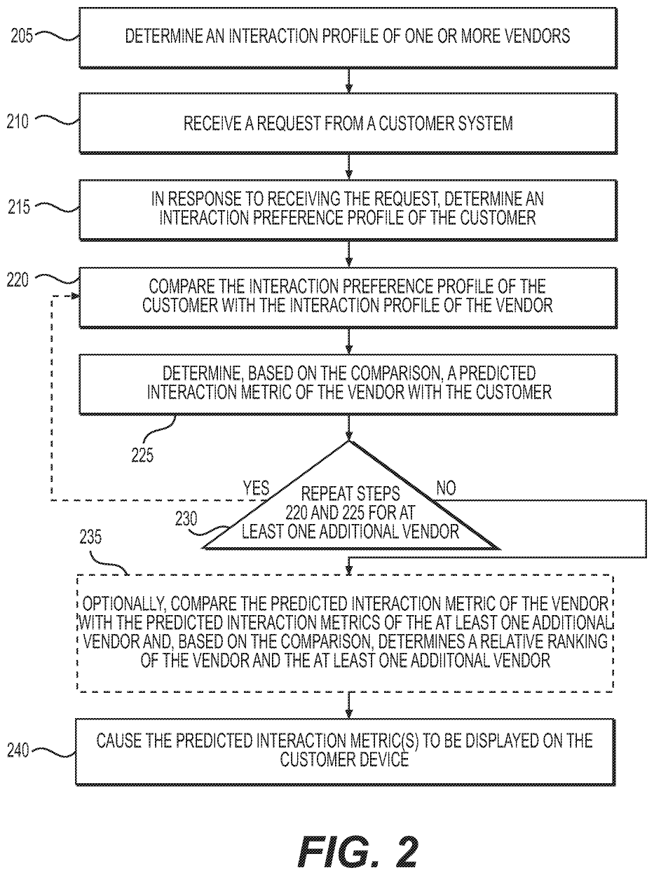

FIG. 2 illustrates an exemplary process for using a machine learning model to determine the alignment between customer preferences and vendor characteristics for an interaction pursuant to a negotiated transaction. At step 205, the recommendation system 120 may determine an interaction profile of one or more vendors associated with the recommendation system 120. As used herein, being “associated” with the recommendation system 120 may indicate that the recommendation system 120 includes data related to the vendor and/or the vender is predetermined to offer the type of negotiated transactions desired by the customer. In various embodiments, vendors are associated manually, via an automated process such as an algorithm that communicates with the social information systems(s) 110, or via another process.

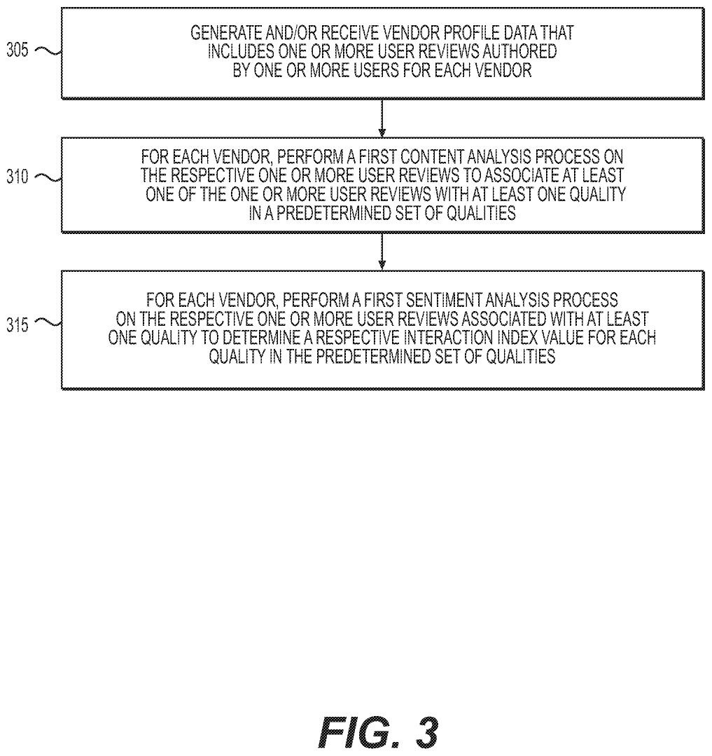

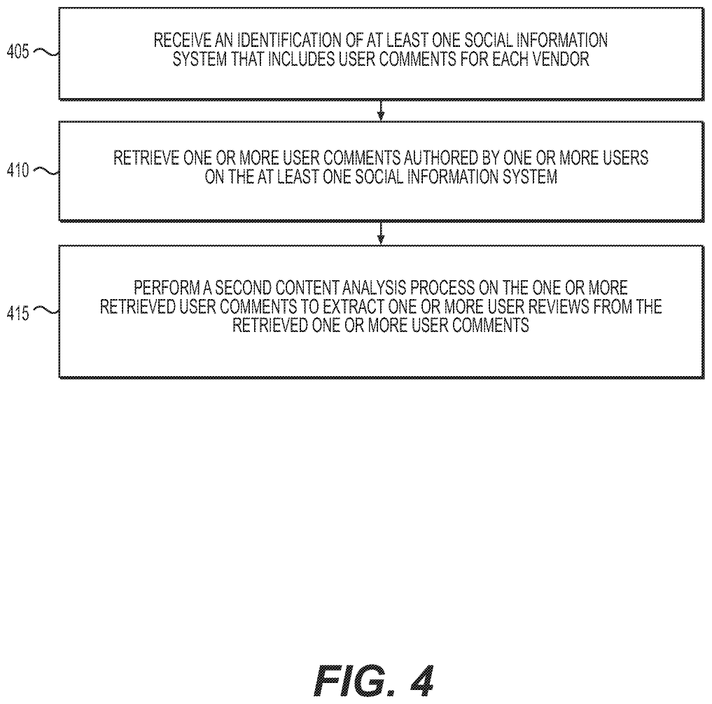

The interaction profile of a vendor determined at step 205 may be a qualitative assessment of the vendor's interaction characteristics, and may be determined based on historical data, as discussed in further detail below with regard to FIGS. 3 and 4. In an interaction profile of a vendor, a vendor may be characterized based on a predetermined set of qualities. The interaction profile of a vendor may include a respective interaction index value that represents a qualitative assessment of the vendor along a spectrum for each quality in the predetermined set of qualities.

For example, a vendor that is historically an excessive haggler might be characterized with a value of nine on a spectrum of one to ten for the quality of haggling, while a vendor that historically engages in little haggling might be characterized with a value of two on the same spectrum. It should be understood that the interaction index values and their associated spectra are qualitative, and are not necessarily quantitative or a rating. In other words, a higher or lower value along a spectrum is not necessarily indicative of a better or worse characterization, respectively.

In various embodiments, the predetermined set of qualities may include, but are not limited to, one or more of transaction speed, level of human interaction, level of haggling, level of detail in negotiations, level of vendor friendliness, a level of formality in negotiations, an amount of technology used in interactions, purchase price, difference between advertised and purchase prices, involvement of a type of employee such as manager or trainee or the like, or involvement of a particular employee at a vendor. Other qualities also may be used in various embodiments. Each quality may be associated with a respective spectrum, e.g., slow to fast transaction speed, little-to-no human interaction to constant human interaction, etc., whereby an interaction index value of a vendor for a particular quality may characterize where historical interactions with that vendor fall along the associated spectrum.

In various embodiments, step 205 may be performed at regular intervals, at a predetermined time, and/or in response to an instruction received by the recommendation system 120. In some embodiments, step 205 may be performed iteratively for each vendor in a set of vendors. In some embodiments, step 205 may be performed continuously.

In some embodiments, interaction index values of a vendor may be tracked over time. In some embodiments, the recommendation system 120 may be configured to identify changes and/or patterns over time for the interaction index values of a vendor. For example, in some embodiments, the recommendation system 120 compares the interaction profiles of the vendors after the performance of step 205 at the intervals discussed above. In some embodiments, the recommendation system 120 continuously performs step 205 for various vendors. In some embodiments, the recommendation system 120 repeats step 205 for a vendor in response to new data associated to that vendor being received.

At step 210, the recommendation system 120 may receive a request from the customer system 105. In some embodiments, the request may be a request to add a customer associated with the customer system 105 to the recommendation system 120. In some embodiments, the request may be a search request from the customer associated with the customer system 105 for finding a vendor in order to conduct a negotiated transaction. In some embodiments, the request may be an automated request from the customer system 105, the recommendation system 120, or another system such as, for example, an automated alert that is scheduled to occur at predetermined intervals.

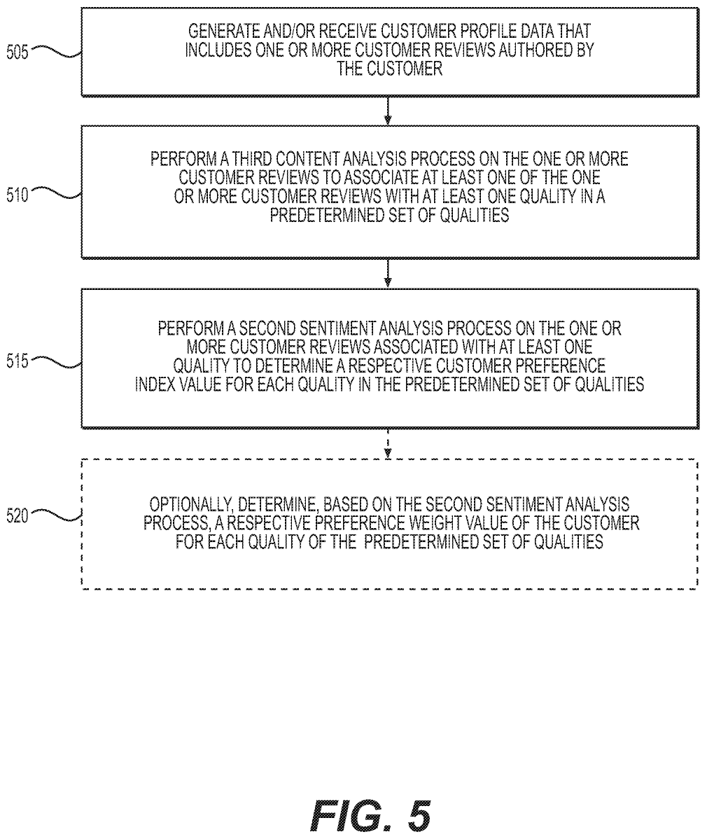

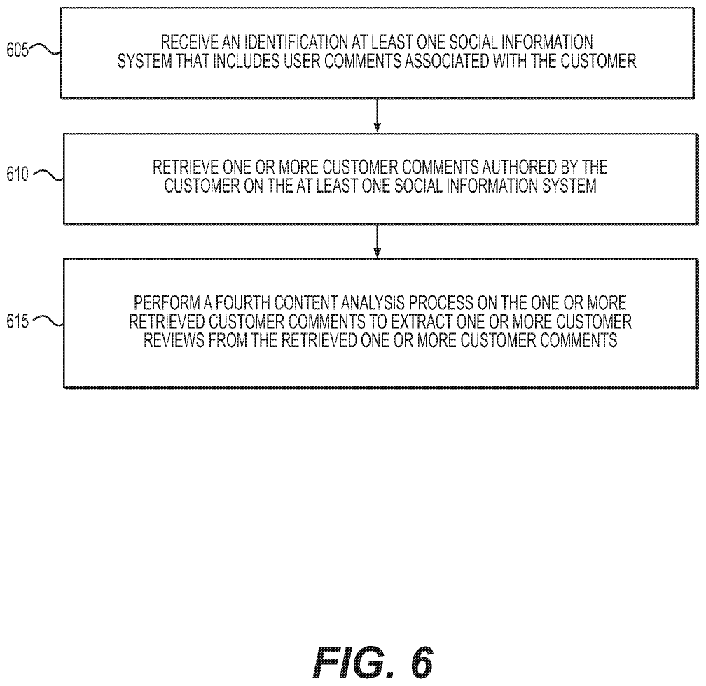

At step 215, in response to receiving the request from the customer system 105 at step 210, the recommendation system 120 may determine an interaction preference profile of the customer. An interaction preference profile of a customer may be a qualitative assessment of the customer's preferences for characteristics of an interaction with a vendor, and may be determined based on historical data, as discussed in further detail below with regard to FIGS. 5 and 6. In some embodiments, the recommendation system 120 may perform the determining of the interaction preference profile of the customer of step 215 in conjunction with the determining of the interaction profile of the vendor at step 205. In some embodiments, steps 205 and 215 may be performed asynchronously.

In some embodiments, interaction preference index values of a customer may be tracked over time. In some embodiments, the recommendation system 120 may be configured to identify changes and/or patterns over time for the interaction preference index values of a customer.

Customer preferences may be characterized based on the same predetermined set of qualities utilized for the interaction profiles of vendors, and thus the interaction preference profile of a customer may include a respective customer preference index value that represents a qualitative assessment of the customer's preferences along the associated spectrum for each quality. For example, a customer that prefers to haggle might be characterized with a value of nine on the spectrum of one to ten for the quality of haggling, while a customer that prefers not to engage in haggling might be characterized with a value of two on the same spectrum.

In some embodiments, the interaction preference profile of the customer additionally includes a respective preference weight value of the customer for each quality in the predetermined set of qualities. In some embodiments, a preference weight value may be a quantitative value indicative of an importance that a particular quality holds for the customer, e.g. an eight on a scale of one to ten. In some embodiments, the preference weight value may be qualitative, e.g. “high” selected from the options of “low,” “medium,” and “high.” In an example, a customer may prefer not to haggle, and this preference may be very important to the customer. With the preference not to haggle, the interaction preference profile of the customer may have an interaction index value of two for the quality of haggling, and with the high importance for this preference, the interaction preference profile of the customer may have a preference weight value of nine associated with the quality of haggling.

At step 220, the recommendation system 120 may compare the interaction preference profile of the customer with the interaction profile of the vendor, as discussed in further detail below. At step 225, the recommendation system 120 may determine, based on the comparison between the interaction preference profile of the customer with the interaction profile of the vendor from step 220, a predicted interaction metric of the vendor with the customer. The predicted interaction metric may be indicative of an alignment between the transaction preferences of the customer and the historical transaction qualities of the vendor. In various embodiments, the predicted interaction metric may be a quantitative score, a percentage, and/or qualitative rating such as high, medium, or low, or the like. Various aspects of the comparison and the determination of the predicted interaction metric are discussed in more detail below.

Optionally, at step 230, steps 220 and 225 may be repeated for at least one additional vendor. In other words, as illustrated in FIG. 2, in some embodiments, step 220 for comparing the interaction profile of a vendor with the interaction preference profile of a customer and step 225 for determining a predicted interaction metric are iterated for different vendors. In some embodiments, the recommendation system 120 may select at least a portion of the one or more vendors associated with the recommendation system 120 to be processed via such iteration of steps 220 and 225 based on one or more of, for example, transaction criteria received from the customer device 105, historical data for the customer, or other factors. In some embodiments, transaction criteria received from the customer device may include one or more of a physical location of the customer, a location of a respective vendor, an availability of a product, a price of the product at the respective vendor, or a requested average user review rating for vendors. In some embodiments, iterations of steps 220 and 225 are performed successively. In some embodiments, iterations of steps 220 and 225 are performed in parallel, i.e. multiple interaction profiles of various vendors are compared with the interaction preference profile of the customer, and a predicted interaction metric for each of the vendors is determined.

Optionally, at step 235, the recommendation system 120 may compare the predicted interaction metric of the vendor with the predicted interaction metrics of the at least one additional vendor and, based on the comparing of the predicted interaction metrics with each other, determine a relative ranking of the vendor and the at least one additional vendor according to a ranking algorithm. Any acceptable ranking algorithm may be used.

At step 240, the recommendation system 120 may cause the predicted interaction metric(s) to be displayed on the customer device 105. For example, in some embodiments, the recommendation system 120 may transmit data to the customer device 105 that includes one or more of the vendor(s) with interaction profile(s) that were compared with the interaction preference profile of the customer, the resulting predicted interaction metric(s), and the determined relative ranking of the vendor(s). In some embodiments, the recommendation system 120 may cause the predicted interaction metric(s) to be displayed on the customer device 105 such that the predicted interaction metric(s) are arranged according to the determined relative ranking of the vendor(s).

In some embodiments, such as embodiments in which transaction criteria is received from the customer device 105, the interaction metric(s) are displayed as search results corresponding to the transaction criteria arranged in an order based on the determined relative ranking of the vendor(s). For example, a user may search for a particular make or model of a vehicle at a particular price point. The recommendation system 120 may display a listing of vendors that satisfy such transaction criteria, and that are arranged in an order based on the relative interaction metrics of the vendors.

In some embodiments, the interaction metric is used as a transaction criteria for a search from the user. In other words, the interaction metric of a vendor may be one of the criteria taken into account for returning results to a query. In some embodiments, a particular vendor with a high interaction metric may be listed as a result to a query from a user while satisfying only some or none of the other transaction criteria of the user.

In some embodiments, step 240 may be performed in succession to one or more of steps 225-235. In some embodiments, step 240 may be performed in response to a request received from the customer device 105. For example, in an instance where the interaction preference profile of the customer and the predicted interaction metric(s) were previously determined in response to a previous request from the customer device 105, the recommendation system 102, in response to a subsequent request, can display the previously determined interaction preference profile of the customer and the predicted interaction metric(s), rather than repeat the performance of steps 215-235.

FIG. 3 illustrates an exemplary process for using the machine learning model to determine an interaction profile of one or more vendors for step 205 of FIG. 2. At step 305, the recommendation system 120 may generate and/or receive vendor profile data that includes one or more user reviews authored by one or more users for each vendor associated with the recommendation system 120, as discussed in more detail below with regard to FIG. 4. At step 310, for each associated vendor, the recommendation system 120 may perform a first content analysis process on the respective one or more user reviews to associate at least one of the one or more user reviews with at least one quality in the predetermined set of qualities.

Any content analysis process is usable and within the scope of this disclosure. For example, in some embodiments, the recommendation system 120 may perform a process that identifies keywords in the one or more user reviews that are predetermined to be associated with one or more of the qualities in the predetermined set of qualities. In some embodiments, the recommendation system 120 may perform a process that identifies a subject category for text, and associates user reviews to qualities that have subjects with a predetermined association with those qualities.

In some embodiments, the first content analysis process not only associates a review with a particular quality, but also associates the review with a particular index value along the spectrum associated with the quality. For example, the phrase “all of the back and forth talk” in a review could result in the review being associated with a high index value on the spectrum for the quality for haggling.

At step 315, for each vendor, the recommendation system 120 may perform a first sentiment analysis process on the respective one or more user reviews associated with at least one quality to determine a respective interaction index value for each quality in the predetermined set of qualities. In other words, the recommendation system 120 may apply the first sentiment analysis process to each user review of the vendor that was associated with at least one quality to determine a sentiment for each review, and then determine an interaction index value for each quality based on the sentiments determined for reviews associated with that quality. In some embodiments, the sentiment of a review is defined by a quantitative judgement value, e.g. a value along a spectrum, with a low value along the spectrum being indicative of a negative sentiment and a high value along the spectrum being indicative of a positive sentiment. In some embodiments, the sentiment of a review is defined by a qualitative judgement value, e.g. −1 for negative, 0 for neutral, and +1 for positive. In some embodiments, the qualitative values are associated with quantitative values along a spectrum, e.g. with the negative −1 qualitative value corresponding with a 2 on a 1-10 scale, the neutral 0 corresponding with a 5 on the 1-10 scale, and the positive +1 corresponding to an 8 on the 1-10 scale. It should be understood that the above are examples only, and that any schema for the sentiment and/or respective interaction index value may be used.

User reviews generally include one or more of text or a rating, e.g., a score, a number of stars, etc. In some embodiments, the first sentiment analysis process may include a normalizing process that translates the various types of ratings that may be present in the respective one or more reviews into a common quantitative scale. For example, a two on a one-to-five scale can be translated to a 0.3 score, while a 97% recommendation score can be translated to a 0.97 score, etc. It should be understood that the foregoing translated rating as a decimal score is an example only, and that any acceptable schema for the translated rating is usable and within the scope of this disclosure.

Any acceptable sentiment analysis process for processing the text of the one or more reviews is usable and within the scope of this disclosure. For example, in some embodiments, the recommendation system 120 may perform a process that identifies connotations of words and/or phrases in text that are predetermined to be associated with varying values along a spectrum associated with judgement, with negative connotations having a low judgement value and positive connotations having a high judgement value. In some embodiments, the processing of the text is based on, or weighted by, the translated review score. For example, the recommendation system 120 can be more likely to associate a review with low judgement value if the review included a low rating, and vice versa.

In some embodiments, the recommendation system 120 may use the judgement value determined for a review, in conjunction with the quality associated with the review via the first content analysis process, to determine a sentiment of the user for the particular value on the spectrum for the associated quality. For example, a review might include the sentence “I couldn't stand all of the back and forth talk.” As discussed above, the recommendation system 120 could associate the review with a high value along the spectrum for the quality of haggling due to the phrase “all of the back and forth talk.” Additionally, the recommendation system 120 could associate that review with a low judgement value due to the phrase “I can't stand . . . ” to determine a sentiment of the review that includes a low judgement value for a high index value for haggling.

Based on the various sentiments of the reviews associated with each quality, the first sentiment analysis process may determine the overall interaction index value for each quality in the predetermined set of qualities. In some embodiments, the first sentiment analysis process may include an aggregation algorithm, clustering algorithm, or the like that is usable to amalgamate positive and negative sentiments about various values of a quality spectrum into an overall interaction index value for the quality. For example, in a set of reviews associated with haggling, the reviews generally have high judgement values for low haggling values and low judgement values for high haggling values. The first sentiment analysis process may use an algorithm to amalgamate the sentiments of the set of reviews to determine an interaction index value of 2 out of 10 for haggling for this particular vendor. Any acceptable amalgamation algorithm or the like is usable and within the scope of this disclosure.

In some embodiments, the algorithm of the first sentiment analysis may determine multiple interaction index values for one or more qualities. For example, a vendor might historically either engage in a lot of haggling with some customers, or engage in little to no haggling with other customers.

In some instances, no reviews might be associated with a particular quality for a particular vendor. In some embodiments, the sentiment analysis process may assign a predetermined default interaction index value to a quality for a vendor that is unassociated with any reviews. For example, if the first content analysis process does not associate any reviews for a particular vendor with the quality of haggling, the sentiment analysis process can assign a default interaction index value of five out of ten along the spectrum for the quality of haggling. In some embodiments, the recommendation system 120 is configured to ignore or reduce the weight of a quality that is not associated with any review. In other words, in some embodiments, when comparing the vendor interaction profile with reference to the interaction preference profile of the customer, the comparison may only consider qualities that are represented in both the interaction profile of the vendor and the interaction preference profile of the customer.

FIG. 4 illustrates an exemplary process for using the machine learning model to generate vendor profile data for step 305 of FIG. 3. At step 405, the recommendation system 120 may receive an identification of at least one social information system 110 that includes user comments for each vendor associated with the recommendation system 120. In various embodiments, the identification is received manually from a user, from a predetermined list of social information systems 110, from an algorithm that automatically identifies social information system 110, and/or another source.

At step 410, the recommendation system 120 may retrieve one or more user comments authored by one or more users on the at least one social information system 110. In some embodiments, the retrieval may include communicating with the social information system 110 over the electrical network 115. In some embodiments, the retrieval may include accessing data stored on the recommendation system 120 or on other sources.

At step 415, the recommendation system 120 may perform a second content analysis process on the one or more retrieved user comments to extract one or more user reviews from the retrieved one or more user comments. In some instances, a user comment may not be related to a vendor or transaction, or may not include any rating or review of a vendor by the user. Any acceptable content analysis process is usable and within the scope of this disclosure. In some embodiments, the first content analysis process and the second content analysis process are similar or are the same process using different criteria such as different keywords or subjects. In some embodiments, the first content analysis process and the second content analysis process are different processes.

FIG. 5 illustrates an exemplary process for using the machine learning model to determine an interaction profile of one or more vendors for step 215 of FIG. 2. At step 505, the recommendation system 120 may generate and/or receives customer profile data that includes one or more customer reviews authored by the customer, as discussed in more detail below with regard to FIG. 6. At step 510, the recommendation system 120 may perform a third content analysis process on the one or more customer reviews to associate at least one of the one or more customer reviews with at least one quality in the predetermined set of qualities.

Any acceptable content analysis process is usable and within the scope of this disclosure. In some embodiments, the third content analysis process and the first content analysis process may be similar. In some embodiments, the first content analysis process and the first content analysis process may be different processes. In some embodiments, the third content analysis process not only associates a review with a particular quality, but also associates the review with a particular index value along the spectrum associated with the quality.

At step 515, the recommendation system 120 may perform a second sentiment analysis process on the respective one or more customer reviews associated with at least one quality to determine a respective customer preference index value for each quality in the predetermined set of qualities. In other words, the recommendation system 120 may apply the second sentiment analysis process to each user review from the customer that was associated with at least one quality to determine a sentiment for each review, and then may determine a customer preference index value for each quality based on the sentiments determined for reviews associated with that quality.

Any acceptable sentiment analysis process is usable and within the scope of this disclosure. In some embodiments, the second sentiment analysis process and the first sentiment analysis process may be similar. In some embodiments, the first sentiment analysis process and the second sentiment analysis process may be different processes. In some embodiments, the sentiment of a review may be defined by a judgement value along a spectrum, with a low value along the spectrum being indicative of a negative sentiment and a high value along the spectrum being indicative of a positive sentiment.

As with user reviews, customer reviews generally include one or more of text or a rating, e.g., a score, a number of stars, etc. In some embodiments, the second sentiment analysis process may include a normalizing process that translates the various types of ratings that may be present in the respective one or more reviews into a common quantitative scale. In some embodiments, the processing of the text is based on, or weighted by, the translated review score. For example, the recommendation system 120 can be more likely to associate a review with low judgement value if the review included a low rating, and vice versa.

In some embodiments, the recommendation system 120 may use the judgement value determined for a review, in conjunction with the quality associated with the review via the third content analysis process, to determine a sentiment of the customer for the particular value on the spectrum for the associated quality. For example, a review might include the sentence “I couldn't stand all of the back and forth talk.” The recommendation system 120 could associate the review with a high value along the spectrum for the quality of haggling due to the phrase “all of the back and forth talk.” Additionally, the recommendation system 120 could associate that review with a low judgement value due to the phrase “I can't stand . . . ” to determine a sentiment of the review that includes a low judgement value for a high index value for haggling.

Based on the various sentiments of the reviews associated with each quality, the second sentiment analysis process may determine the overall interaction preference index value for each quality in the predetermined set of qualities. In some embodiments, the second sentiment analysis process may include an aggregation algorithm, clustering algorithm, or the like that is usable to amalgamate positive and negative sentiments about various values of a quality spectrum into an overall interaction index value for the quality. For example, in a set of reviews associated with haggling, the reviews generally have high judgement values for low haggling values and low judgement values for high haggling values. The second sentiment analysis process may use an algorithm to amalgamate the sentiments of the set of reviews to determine an interaction preference index value of 2 out of 10 for haggling for the customer. Any acceptable amalgamation algorithm or the like is usable and within the scope of this disclosure.

In some embodiments, the algorithm of the second sentiment analysis may determine multiple interaction preference index values for one or more qualities. For example, a customer might historically prefer to either engage in a lot of haggling or no haggling at all, but prefers not to engage in a middling level of haggling.

Optionally, at step 520, the recommendation system 120 may determine, based on the results of the second sentiment analysis process, a respective preference weight value of the customer for each quality of the predetermined set of qualities. In an example, customer reviews associated with the quality of haggling include several reviews with an index value low on the spectrum and a high judgement score, as well as several reviews with an index value high on the spectrum and a low judgement score. In other words, the customer historically had a very low sentiment when a vendor engaged in a lot of haggling, and a very high sentiment when a vendor did not engage in haggling. The recommendation system 120 may determine, based on this historical data, that the quality of haggling is very important to the customer. For instance, in some embodiments, the recommendation system 120 may determine the average deviation of judgement values for reviews associated with a quality from a middle point on the judgement spectrum. Thus, if reviews associated with a particular quality tend to have either more positive or more negative judgements, then the recommendation system 120 assigns a higher preference weight to that quality.

In another example, customer reviews associated with the quality of time to complete a transaction may include reviews with judgement values that generally fall near the middle of the judgement spectrum. Due to the low average deviation of the judgement scores from the middle of the judgement spectrum, the recommendation system 120 may assign a lower preference weight to the quality of time to complete a transaction.

In some instances, no reviews might be associated with a particular quality for the customer. In some embodiments, the second sentiment analysis process may assign a predetermined default interaction preference index value to a quality for a customer that is unassociated with any reviews. In some embodiments, the second sentiment analysis may assign a preference weight value of zero to a quality for a customer that is unassociated with any reviews.

FIG. 6 illustrates an exemplary process for using the machine learning model to generate customer profile data for step 505 of FIG. 5. At step 605, the recommendation system 120 may receive an identification of at least one social information system 110 that includes user comments associated with the customer. In some embodiments, the identification may include a listing of accounts associated with the customer and provided by the customer via the customer device 105, e.g., social media accounts, review website accounts, etc. In some embodiments, the identification may be received from historical data that includes a listing of accounts associated with the customer and stored on one or more of the recommendation system 120 or the customer device 105.

At step 610, the recommendation system 120 may retrieve one or more customer comments authored by the customer on the at least one social information system 110. In some embodiments, the retrieval may include communicating with the social information system 110 over the electrical network 115. In some embodiments, the retrieval may include accessing data stored on the recommendation system 120 or on other sources.

At step 615, the recommendation system 120 may perform a fourth content analysis process on the one or more retrieved customer comments to extract one or more customer reviews from the retrieved one or more customer comments. In some instances, a customer comment may not relate to a vendor or transaction, or may not include any rating or review of a vendor by the user. Any acceptable content analysis process is usable and within the scope of this disclosure. In some embodiments, the fourth content analysis process and the second content analysis process may be similar or the same process. In some embodiments, the fourth content analysis process and the second content analysis process may be different processes.

With reference again to FIG. 2, in which the interaction preference profile of the customer and the interaction profile of the vendor are compared (step 220), and in which a predicted interaction metric of the vendor with the customer is determined, any acceptable processes for comparing the profiles and determining the predicted interaction metric are usable and within the scope of this disclosure.

For example, in some embodiments, the comparison at step 220 may include determining, for each quality, a respective deviation, i.e., a difference, between the interaction preference index value of the customer and the interaction index value of the vendor. In some embodiments, the comparison step 220 may further include, for each quality of the predetermined set of qualities, determining a respective weighted difference by applying the respective preference weight value of the customer to the determined respective difference. In various embodiments, the predicted interaction metric may be determined as the sum or average of the weighted differences, or as a length of a vector defined by the weighted differences, with the respective weighted difference of each quality defining a coordinate along an axis corresponding to that quality in a multidimensional space.

In some embodiments, the respective customer preference index values may define coordinates of the preference profile of the customer in a multi-dimensional space. Each axis in the multidimensional space may correspond to a respective one of the qualities in the predetermined set of qualities. Similarly, the respective interaction index values may define coordinates of the interaction profiles of the one or more vendors in the multi-dimensional space, and the comparison of the vendor and customer profiles may be based on the relative coordinates of the preference profile of the customer and the interaction profiles of the at least the portion of the one or more vendors in the multi-dimensional space.

As discussed above, in some embodiments, steps 220 and 225 may be repeated so as to compare the customer's profile with multiple vendors. In some embodiments, the recommendation system 120 may deploy machine learning techniques, such as linear regression, logistical regression, random forest, gradient boosted machine (GBM), and/or a deep neural network. Supervised or unsupervised training may be employed. For example, unsupervised approaches may include K-means clustering. K-Nearest Neighbors may also be used, which may be supervised or unsupervised. Combinations of K-Nearest Neighbors and an unsupervised cluster technique may also be used. As the machine learning system is trained, the preference profile of the customer and the interaction profiles of the vendors may form clusters in the multi-dimensional space, whereby the closest neighbor interaction profile of a vendor with the customer preference profile determines the vendor with historical interactions having the closest alignment with the customer's preferences.

In some embodiments, one or more of the interaction preference profile of the customer, the interaction profile of the vendor, the predicted interaction metric of the vendor with the customer, or data based on the foregoing may be provided or made accessible to the vendor. The vendor may use such information to one or more of (i) take action to make adjustments to the characteristics of the vendor overall (e.g., decrease a total average time for a transaction), (ii) tailor interactions with the customer so as to more closely align with the customer's preferences, or (iii) offer an incentive or benefit to the customer to mitigate misalignment between the customer's preferences and the vendor's characteristics. In some embodiments, the information made available to the vendor may pertain to a plurality of customers. The vendor may use such data to determine, for example, that increasing the amount of haggling at the vendor may cause the vendor to align with more customers than prior to the increase.

In some embodiments, the information may include adjustments to the vendor's characteristics configured to improve and/or maximize a number of customer's that more closely align with the vendor. In some embodiments, a machine learning technique may be employed to determine adjustments for the vendor that may result in a largest increase in aligned customers. In some embodiments, the information may identify a characteristic niche within a given geographic region. For example, the information may identify that no or relatively few vendors in a region exhibit a high amount of haggling, and/or that a relatively high number of customers in the region prefer a high amount of haggling, and thus that increasing the amount of haggling by the vendor may increase the number of customers more closely aligning with the vendor.

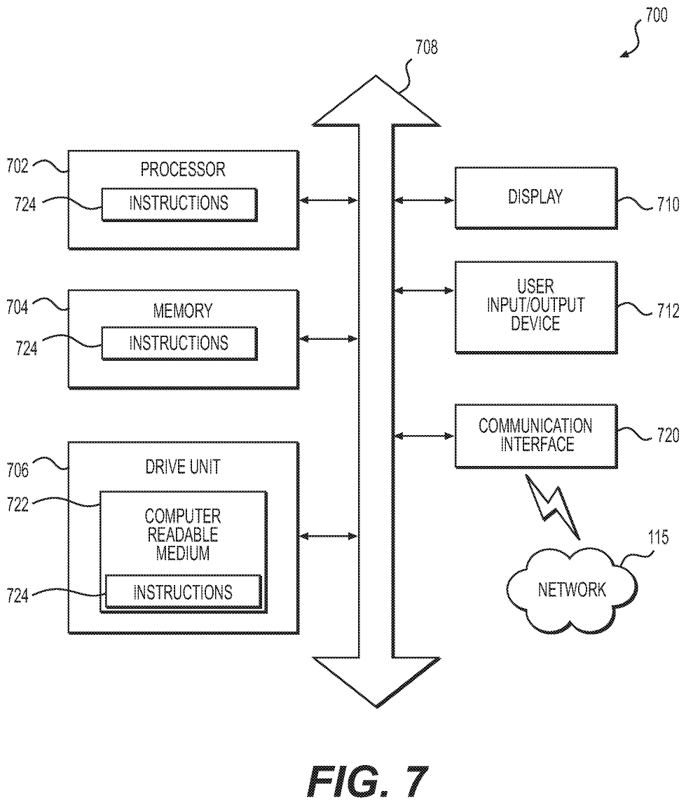

FIG. 7 is a simplified functional block diagram of a computer 700 that may be configured as a device for executing the methods of FIGS. 2-6, according to exemplary embodiments of the present disclosure. FIG. 7 is a simplified functional block diagram of a computer that may be configured as the recommendation system 120, social information system 110, or customer system 105 according to exemplary embodiments of the present disclosure. Specifically, in one embodiment, any of the user devices, servers, etc., discussed herein may be an assembly of hardware 700 including, for example, a data communication interface 720 for packet data communication. The platform also may include a central processing unit (“CPU”) 702, in the form of one or more processors, for executing program instructions. The platform may include an internal communication bus 708, and a storage unit 706 (such as ROM, HDD, SDD, etc.) that may store data on a computer readable medium 722, although the system 700 may receive programming and data via network communications. The system 700 may also have a memory 704 (such as RAM) storing instructions 724 for executing techniques presented herein, although the instructions 724 may be stored temporarily or permanently within other modules of system 700 (e.g., processor 702 and/or computer readable medium 722). The system 700 also may include input and output ports 712 and/or a display 710 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer, an automobile entertainment system, a home entertainment system, etc. Also, the presently disclosed embodiments may be applicable to any type of Internet protocol.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to: the processes shown in FIGS. 2-6, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method, comprising:
determining a vendor interaction preference profile of a customer by:
receiving first data including one or more vendor reviews authored by the customer;
performing a first content analysis process on the one or more vendor reviews to associate at least one of the one or more vendor reviews with at least one quality in a predetermined set of qualities; and
performing a first sentiment analysis process on the at least one vendor review associated with the at least one quality to determine a respective customer preference index value for each quality in the predetermined set of qualities;
comparing the vendor interaction preference profile of the customer with an interaction profile of a vendor, wherein the interaction profile of the vendor includes a respective interaction index value for each quality in the predetermined set of qualities;
based on the comparing of the vendor interaction preference profile of the customer with the interaction profile of the vendor, determining a predicted interaction metric of the vendor with the customer; and
causing the predicted interaction metric to be displayed on a customer device associated with the customer.

2. The computer-implemented method of claim 1, wherein the predetermined set of qualities includes at least one of transaction speed, level of human interaction, level of haggling, level of detail in negotiations, or level of vendor friendliness.

3. The computer-implemented method of claim 1, wherein:
determining the vendor interaction preference profile of the customer further includes, based on the first sentiment analysis process, determining a respective preference weight value of the customer for each quality of the predetermined set of qualities; and
the comparing of the vendor interaction preference profile of the customer with the interaction profile of the vendor is based on the respective preference weight value of the customer for each quality of the predetermined set of qualities.

4. The computer-implemented method of claim 3, wherein:
the comparing the vendor interaction preference profile of the customer with the interaction profile of the vendor includes, for each quality of the predetermined set of qualities:
determining a respective difference between the respective customer preference index value and the respective interaction index value; and
determining a respective weighted difference by applying the respective preference weight value of the customer to the determined respective difference; and
the determining the predicted interaction metric of the vendor with the customer includes determining a length of a vector having coordinates defined by the respective weighted differences.

5. The computer-implemented method of claim 1, further comprising:
comparing the predicted interaction metric of the vendor with a predicted interaction metric of at least one additional vendor;
based on the comparing of the predicted interaction metric of the vendor with the predicted interaction metric of the at least one additional vendor, ranking the vendor and the at least one additional vendor according to a ranking algorithm; and
causing an indication of the ranks of the vendor and the at least one additional vendor to be displayed on the customer device.

6. The computer-implemented method of claim 1, further comprising:
generating the first data by:
receiving an identification of at least one social information account associated with the customer;
retrieving one or more customer comments authored by the customer on the at least social information account; and
performing a second content analysis process on the retrieved one or more customer comments to extract the one or more vendor reviews from the retrieved one or more customer comments.

7. The computer-implemented method of claim 6, wherein at least one of (i) the generating of the first data and the determining of the vendor interaction preference profile, or (ii) the comparing of the preference profile of the customer with the interaction profile of the vendor, the determining of the predicted interaction metric of the vendor, and the displaying of the predicted interaction metric on the customer device is performed in response to one or more requests received from the customer device.

8. The computer-implemented method of claim 7, further comprising:
generating second data by:
receiving an identification of at least one social information system that includes user comments associated with the vendor;
retrieving one or more user comments authored by one or more users on the at least one social information system; and
performing a third content analysis process on the retrieved one or more user comments to extract one or more user reviews of the vendor; and
determining the interaction profile of the vendor by:
performing a fourth content analysis process on the one or more user reviews of the vendor to associate at least one of the one or more user reviews with at least one quality in the predetermined set of qualities; and
performing a second sentiment analysis process on the at least one user review associated with at least one quality to determine the respective interaction index value for each quality in the predetermined set of qualities.

9. The computer-implemented method of claim 8, wherein the generating of the second data and the determining of the interaction profile of the vendor are performed asynchronously to the request received from the customer device.

10. A computer-implemented method, comprising:
determining an interaction profile of one or more vendors by:
generating vendor profile data that includes a respective one or more user reviews authored by one or more users for each vendor of the one or more vendors;
for each vendor of the one or more vendors, performing a first content analysis process on the respective one or more user reviews to associate at least one of the one or more user reviews with at least one quality in a predetermined set of qualities; and
for each vendor of the one or more vendors, performing a first sentiment analysis process on the at least one user review associated with at least one quality to determine a respective interaction index value for each quality in the predetermined set of qualities; and
in response to receiving a request from a customer device associated with a customer:
determining an interaction preference profile of the customer by:
generating customer profile data that includes one or more vendor reviews authored by the customer;
performing a second content analysis process on the one or more vendor reviews to associate at least one of the one or more vendor reviews with at least one quality in the predetermined set of qualities; and
performing a second sentiment analysis process on the at least one vendor review associated with at least one quality to determine a respective customer preference index value for each quality in the predetermined set of qualities;
comparing the preference profile of the customer with the interaction profiles of at least a portion of the one or more vendors;
based on the comparing the preference profile of the customer with the interaction profiles of the at least the portion of the one or more vendors, determining a respective predicted interaction metric of each of the at least the portion of the one or more vendors with the customer; and
causing the respective predicted interaction metric of each of the at least the portion of the one or more vendors to be displayed on the customer device.

11. The computer-implemented method of claim 10, wherein the at least the portion of the one or more vendors is determined based on transaction criteria received from the customer device.

12. The computer-implemented method of claim 11, wherein the transaction criteria includes one or more of location of the customer, location of a respective vendor, availability of a product, price of the product at the respective vendor, or average user review rating of the respective vendor.

13. The computer-implemented method of claim 10, wherein generating the vendor profile data includes:
receiving an identification of at least one social information system that includes user comments of each vendor of the one or more vendors;
retrieving one or more user comments authored by one or more users on the at least one social information system; and
performing a third content analysis process on the retrieved one or more user comments to extract the respective one or more user reviews of each vendor.

14. The computer-implemented method of claim 10, wherein generating the customer profile data includes:
receiving an identification of at least one social information account associated with the customer;
retrieving one or more customer comments authored by the customer on the at least social information account; and
performing a third content analysis process on the retrieved one or more customer comments to extract the one or more vendor reviews from the retrieved one or more customer comments.

15. The computer-implemented method of claim 10, wherein:
determining the preference profile of the customer further includes determining, based on the second sentiment analysis process, a respective preference weight value of the customer for each quality of the predetermined set of qualities; and
the comparison of the preference profile of the customer with the interaction profiles of the at least the portion of the one or more vendors is performed based on the respective preference weight vales for each quality of the predetermined set of qualities.

16. The computer-implemented method of claim 15, wherein:
comparing the preference profile of the customer with the interaction profiles of the at least the portion of the one or more vendors includes, for each vendor of the one or more vendors:
for each quality of the predetermined set of qualities, determining a respective difference between the respective customer preference index value and the respective interaction index value; and
for each quality of the predetermined set of qualities, determining a respective weighted difference by applying the respective preference weight value of the customer to the determined respective difference; and
determining the predicted interaction metrics of the at least the portion of the one or more vendors with the customer includes, for each vendor of the one or more vendors, determining a length of a respective vector having coordinates defined by the respective weighted differences.

17. The computer-implemented method of claim 10, wherein:
the respective customer preference index values define coordinates of the preference profile of the customer in a multi-dimensional space, each axis in the multidimensional space corresponding to a respective one of the qualities in the predetermined set of qualities;
the respective interaction index values define coordinates the interaction profiles of the one or more vendors in the multi-dimensional space; and
the comparing of the preference profile of the customer with the interaction profiles of the at least the portion of the one or more vendors is based on the relative coordinates of the preference profile of the customer and the interaction profiles of the at least the portion of the one or more vendors in the multi-dimensional space.

18. The computer-implemented method of claim 10, further comprising:
comparing the predicted interaction metrics of the at least the portion of the one or more vendors with each other;
based on the comparing of the predicted interaction metrics with each other, ranking the at least the portion of the one or more vendors according to a ranking algorithm; and
causing an indication of the ranks of the at least the portion of the one or more vendors to be displayed on the customer device.

19. The computer-implemented method of claim 10, wherein the predetermined set of qualities includes at least one of transaction speed, level of human interaction, level of haggling, level of detail in negotiations, or level of vendor friendliness.

20. A system, comprising:
a memory storing instructions; and
at least one processor executing the instructions to perform a process including:
determining an interaction profile of one or more vendors by:
generating vendor profile data that includes a respective one or more user reviews authored by one or more users for each vendor of the one or more vendors;
for each vendor of the one or more vendors, performing a first content analysis process on the respective one or more reviews to associate at least one of the one or more user reviews with at least one quality in a predetermined set of qualities; and
for each vendor of the one or more vendors, performing a first sentiment analysis process on the at least one user review associated with at least one quality to determine a respective interaction index value for each quality in the predetermined set of qualities; and
in response to receiving a request from a customer device associated with a customer:
determining an interaction preference profile of the customer by:
generating customer profile data that includes one or more vendor reviews authored by the customer;
performing a second content analysis process on the one or more vendor reviews to associate at least one of the one or more vendor reviews with at least one quality in the predetermined set of qualities; and
performing a second sentiment analysis process on the at least one vendor review associated with at least one quality to determine a respective customer preference index value for each quality in the predetermined set of qualities;
comparing the preference profile of the customer with the interaction profiles of at least a portion of the one or more vendors;
based on the comparing of the preference profile of the customer with the interaction profiles of the at least the portion of the one or more vendors, determining a respective predicted interaction metric of each of the at least the portion of the one or more vendors with the customer; and
causing the respective predicted interaction metrics to be displayed on the customer device.
